(19) United States
(12) Patent Application Publication
(10) Pub. No.: US 2002/0185080 A1
(43) Pub. Date: Dec. 12, 2002

(54) Self-photoperiodic acclimatization aquatic pedestal

(76) Inventor: Eliud Ortiz, Ozone Park Queens, NY (US)

Correspondence Address: Eliud Ortiz, 109-18 98th Street APT 2, Ozone Park Queens, NY, 11417, US

(21) Appl. No.: 10/115,599

(22) Filed: Apr. 1, 2002

Related U.S. Application Data
(63) Continuation of application No. 09/660,074, filed on Sep. 11, 2000.
Application No. 09/660,074 is a continuation of application No. 08/234,126, filed on Jun. 7, 1994, now abandoned.

(51) Int. Cl. A01K 63/00

(52) U.S. Cl. 119/245

(57) ABSTRACT

Method and apparatus, for ⁴improving aerobe hydraulic photosterilization; ¹thus, acclimate aquatic life to environment by employing a series of ²self-photohygienic aerobe hydraulic conduits (air and water conduits). Consequently, ³generate a self-photoperiodic aquatic acclimatization pedestals. That utilizes lamp source, or sunlight through special crystals ⁵creating continuous magnetic field conductivity. Thus, maximize water purification through “simultaneous exposure of ultraviolet and ozone”, ⁶photo-synthesizing aerobe hydraulic effluent generating ozonization. While ⁷photoperiodic and photocontinuum incubate subject to disease aquatic forms, by employing a core ⁸to prolong photoexposure among substances. Thus, ⁹access abrupt aerobe hydraulic effluent assimilates immediate photosterilization ¹⁰improving ozonization and synergistic radiation. Further employing TiO₂ coated in glaze; thus, ¹¹photoexpose aerobe hydraulic effluent while impedes Sol-gel physical contact with conduits interior surface. Furthermore, comprise Aquarium valve adopter ¹²preventing hydraulic, and organic effluent descent into water reservoir. In addition, employ photohygienic glass generating a ¹³self-photohygiene aquarium; whereby, aquatic chemistry impedes nitrate accumulation.

### CROSS REFERENCES TO RELATED APPLICATIONS

This application is a continuation of Ser. No. 09/660.074 filed Sep. 11, 2000 now waiting for first OA. Ser. No. 08/412,527 filed Feb. 28, 1995, now abandoned which was a continuation in parts of Ser. No. 08/234,126, filed Jun. 07, 1994, now abandoned.

### BACKGROUND—FIELD OF INVENTION

The novel invention relates to the field of sterilization, for ⁴improving aerobe hydraulic photosterilization. Thus, simultaneously ¹acclimate aquatic lifeform to environment, and generate ²self-photohygienic aerobe hydraulic conduits.

### BACKGROUND—DESCRIPTION OF PRIOR ART

According to prior arts, the combination of ultraviolet light and ozone produces synergistic radiation. This radiation eliminates bacteria that ultraviolet, and ozone do not destroy when employed individually. Several prior arts use different method, and apparatus to achieve synergistic radiation. Disclosure: U.S. Pat. No. 4,141,830. Inventor Anthony J. Last. Filed Feb. 1, 1978. Last disclosure; provide an apparatus that purifies liquid such as water; employing an ultraviolet light source. This irradiates air passing through a first chamber surrounding the source. The source irradiates the liquids passing through a second chamber surrounding the first chamber. The air from the first chamber is ozonated by the source; then, bubbled into the water in the second chamber. This ¹⁴maximizes the purification through “simultaneous exposure of ultraviolet and ozone.”

However, this “simultaneous exposure of ultraviolet and ozone” Improves by ⁵creating continuous magnetic field conductivity. Thus, ⁶photosynthesizes aerobe hydraulic effluent generating ozonization conveyed through a ³self-photoperiodic acclimatization aquatic pedestal. Which employ means that ⁷photoperiodic and photocontinuum incubate subject to disease aquatic form; including means, ⁸to prolong photoexposure among substances. Thus, ⁹access abrupt aerobe hydraulic effluent assimilates immediate photosterilization ¹⁰improving ozonization, and synergistic radiation. Since, previously known prolong UV duration greater the outcome of photo-terilization among bacteria. Disclosure: U.S. Pat. No. 4,017,735 Inventor Arthur D. Sleget. Filed. Oct. 24, 1975.

This comes realistic by constructing the photoperiodic, and prolonging means of anodized aluminum; having Sol-gel interior coated in glaze improving the ³self-photoperiodic acclimatization aquatic pedestal. Thus, ¹¹photoexpose aerobe hydraulic effluent while impedes Sol-gel physical contact. Consequently, the prior art fail to generate a ¹³self-photohygiene aquarium. In addition, fail ¹²to prevent hydraulic and organic effluent descent into reservoir. The prior art; also, fail ¹⁵to impede chlorinated water veering into chlorofluorocarbon. Disclosure: U.S. Pat. No. 4,892,712, Inventor David G. Ritchie. Filed. Apr. 23, 1990.

Disclosure: U.S. Pat. No. 4,179,616, Inventor Allan J. Coviellos, and U.S. Pat. No. 3,336,099. Coviellos establish that when air comes expose to UV produces ozone because it contains oxygen. Since previously known, ozonization is a great germicidal to maintain live tropical fish. Bibliography: “Aquarium Fish Breeding” By Ines Scheurmann pg. 40. Some prior arts irradiate oxygen with UV to generate ozone, and synergistic effect among bacteria. Although this effect, realistically disappoint in presence of chlorine because it absorbs UV radiation; thus, produce chlorofluorocarbon (CFC) occasioning ozone depletion. Ozone Depletion: 1988, Doniger, D. D., Politics of the Ozone Layer.

Identical ozone depletion occurs when exposing chlorinated water to any wavelength of UV radiation. Thus, prior arts fail to provide aquatic environment in urban area; hence, water contains considerable dose of chlorine. Since previously known, a process called Sol-gel can achieve photo-dechlorination (PCBs). Disclosure: U.S. Pat. No. 4,892,712, Inventor David G. Ritchie. Filed. Apr. 23, 1990. The prior art, fail to achieve Sol-gel dechlorination, for preserving live tropical fish. This is possible ¹⁶alternating light and Sol-gel reflection generating a constant lunar-solar photoperiod. Bibliography: “Fish Diseases” By Dr. Mark Dulin pg. 8; U.S. Pat. No. 4,106,148. This intermittent photoperiod and dechlorination comes realistic as solar radiation penetrates quartz. Since, previously known Silicon and Quartz are the most common material, for ultraviolet-transmitting lenses. Bibliography: New Grolier Multimedia Encyclopedia release 6, search “quartz and ultraviolet”. The use of Sol-gel coating must not have any physical contact with water. This ¹⁷prevents the Sol-gel coat been absorbed by the constant ozonated hydraulic stream. Ozone has oxidant agent that removes the hardiest surface, moreover when dealing with abrupt aerobe hydraulic turbulence.

### OBJECT AND ADVANTAGES

1 It is an object of the invention to provide the method to acclimate aquatic lifeform to environment.

2 It is an object of the invention to provide the method to generate self-photohygienic aerobe hydraulic conduits.

3 It is an object of the invention to provide the method to generate a self-photoperiodic acclimatization aquatic pedestal.

4 It is an object of the invention to provide the method to improve aerobe hydraulic photosterilization.

5 It is an object of the invention to provide the method to create continuous magnetic field conductivity.

6 It is an object of the invention to provide the method to photosynthesize aerobe hydraulic effluent generating ozonization.

7 It is an object of the invention to provide the method to photoperiodic and photocontinuum incubates subject to disease aquatic forms.

8 It is an object of the invention to provide the method to prolong photoexposure among substances.

9 It is an object of the invention to provide the method to access abrupt aerobe hydraulic effluent assimilates immediate photo-sterilization.

10 It is an object of the invention to provide the method to improve ozonization and synergistic radiation.

11 It is an object of the invention to provide the method to photoexpose aerobe hydraulic impeding Sol-gel physical contact.

12 It is an object of the invention to provide the method to prevent hydraulic and organic effluent descent into reservoir

13 It is an object of the invention to provide the method to generate a self-photohygienic aquarium; whereby, aquatic chemistry impedes nitrate accumulation.

14 It is an object of the invention to provide the method to maximize purification through “simultaneous exposure of ultraviolet and ozone”.

15 It is an advantage of the invention to provide the method to impede chlorinated water turning into chlorofluorocarbon.

16 It is an advantage of the invention to provide the method to alternate of UV light and Sol-gel reflection generating a constant lunar-solar photoperiod.

17 It is an advantage of the invention to provide the method to prevent Sol-gel coat been absorbed by the constant ozonated hydraulic stream.

18 It is an advantage of the invention to provide the method to connect one unit stand after the other repetitively forming a multiple unit stand.

19 It is an advantage of the invention to provide the method to vacuum the nitrate buildup from the series of air and water lines using granulated sodium chloride.

20 It is an advantage of the invention to provide the method to acclimate cold-blooded fish as well as warm-blooded.

21 It is an advantage of the invention to provide the method to transmit ultraviolet light distributed along the air and water stream.

22 It is an advantage of the invention to provide the method to eliminate nitrogen radical by bombarding biological filtration with ozonated aeration.

23 It is an advantage of the invention to provide the method to prevent oxidant agent of ozone dissolve the titanium dioxide coat.

24 It is an advantage of the invention to provide the method to generate synergistic radiation employing minimum sunlight.

25 It is an advantage of the invention to provide the method to reverse the sunlight in the cycle of night providing a constant radiation for chlorine removal.

26 It is an advantage of the invention to provide the method to generate scattering cross-section.

27 It is an advantage of the invention to provide the method to regulate nitrates through the alternation of oxidation and ozonization.

28 It is an advantage of the invention to provide the method to generate and regulate reversible reaction between nitrate and ozone.

29 It is an advantage of the invention to provide the method to regulate aquarium pH through proportional adjusting of acidity and alkalinity.

30 It is an advantage of the invention to provide the method to exchange the flow of oxygen and ozone.

31 It is an advantage of the invention to provide the method to employ a technique that neutralize chlorine and fish waste among each other before settling into storage tank.

Still further objects and advantages will become apparent from a consideration of the ensuing description and accompanying drawings.

### BRIEF EMBODIMENT DESCRIPTION

Foregoing objects, and advantages are further describe in the exercise of the method illustrated in the preferred embodiment in which:

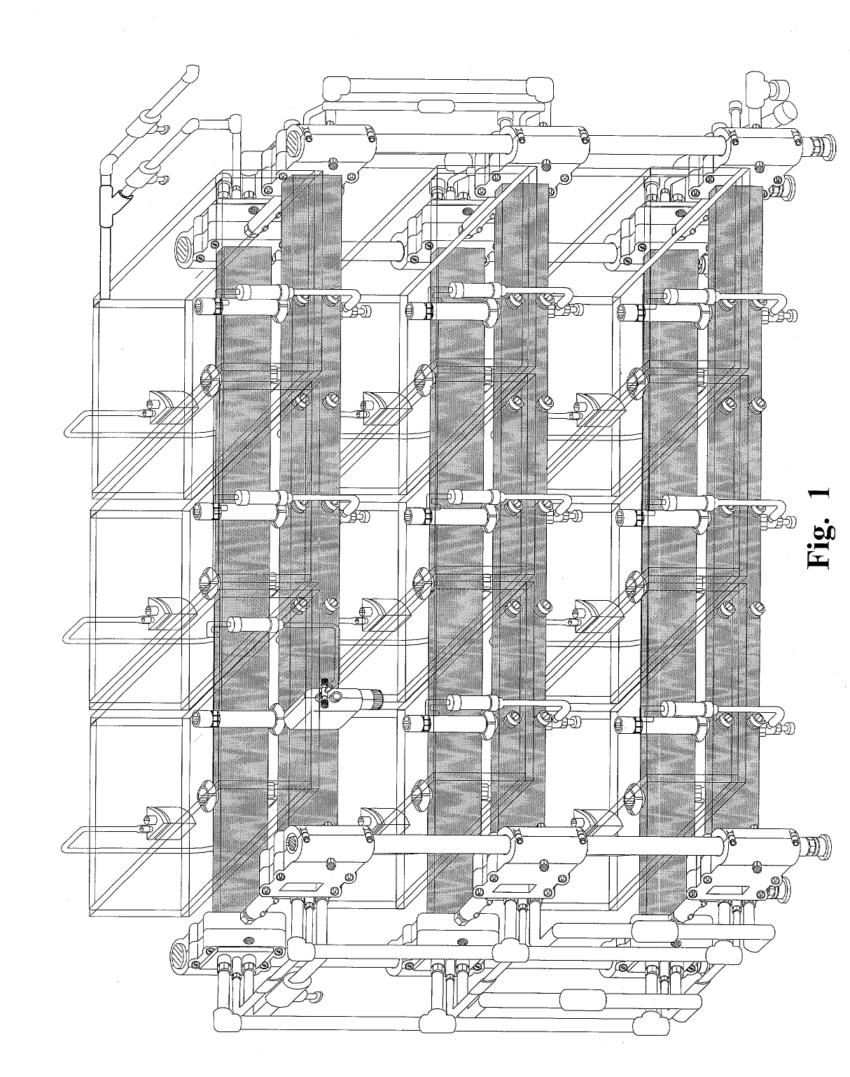

FIG. 1 is a perspective view of an aerobe hydraulic system in form of a multiple aquarium stand, for the conservation of live tropical fish;

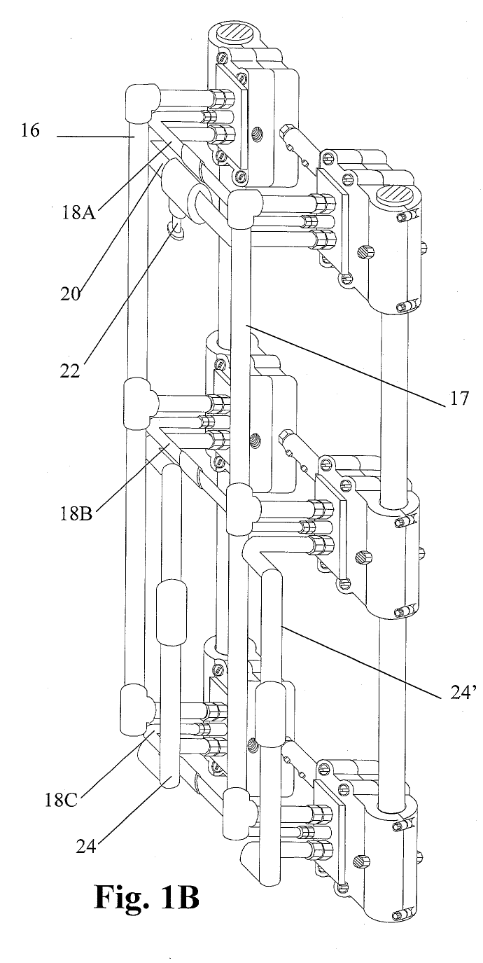

FIG. 2 is a perspective view, taking along the back portion of FIG. 1;

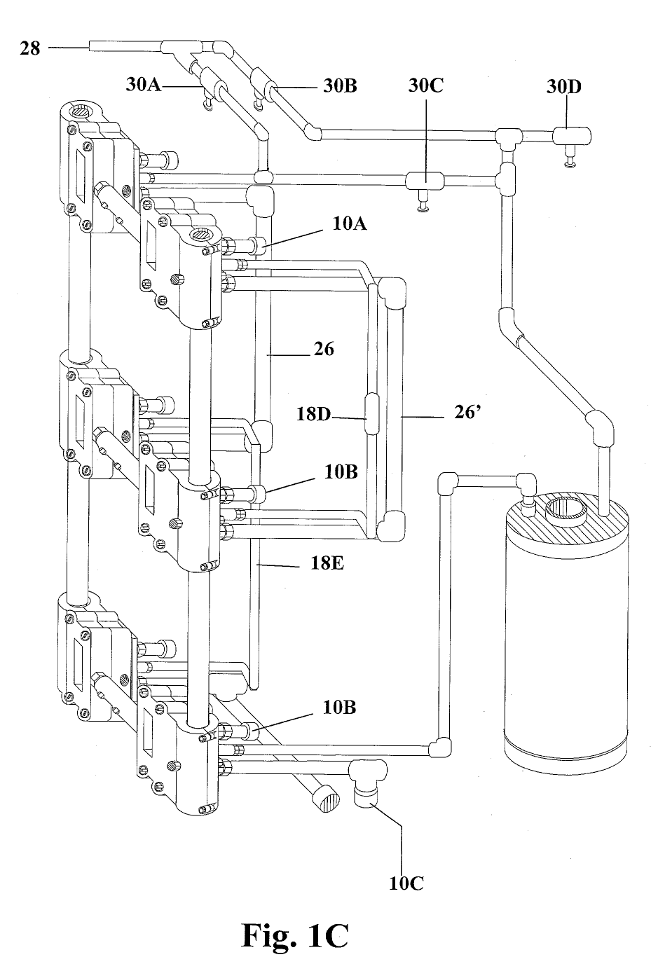

FIG. 3 is a perspective view, taking along the left portion of FIG. 1

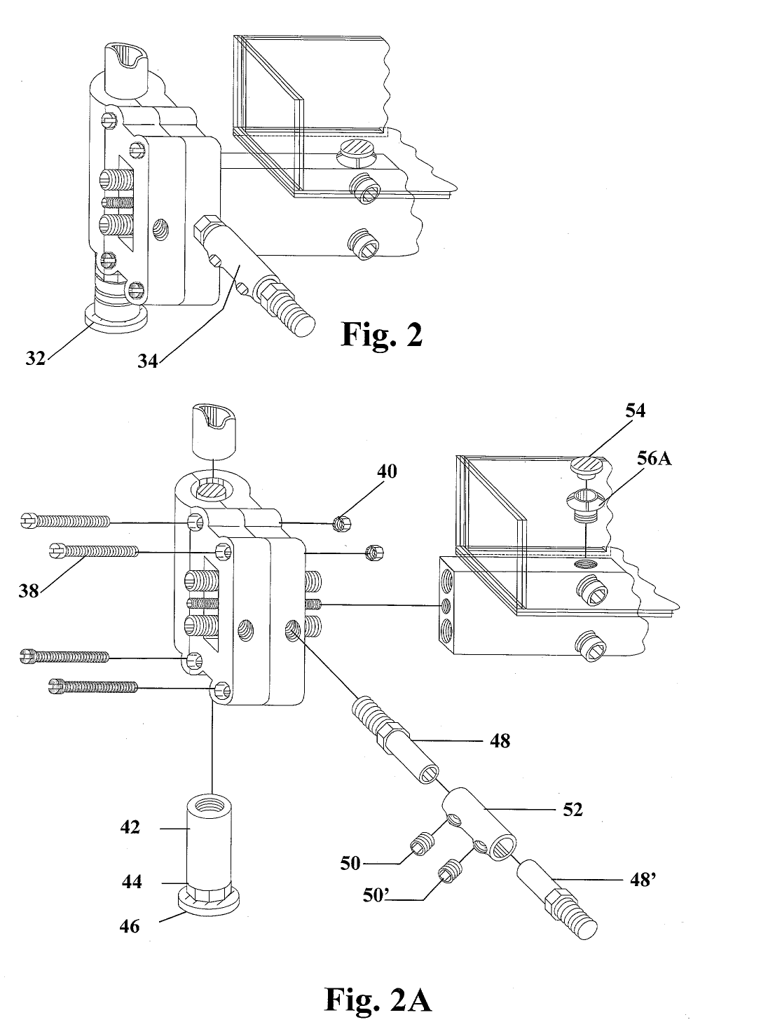

FIG. 4 is a perspective view, taking along the right portion of FIG. 1

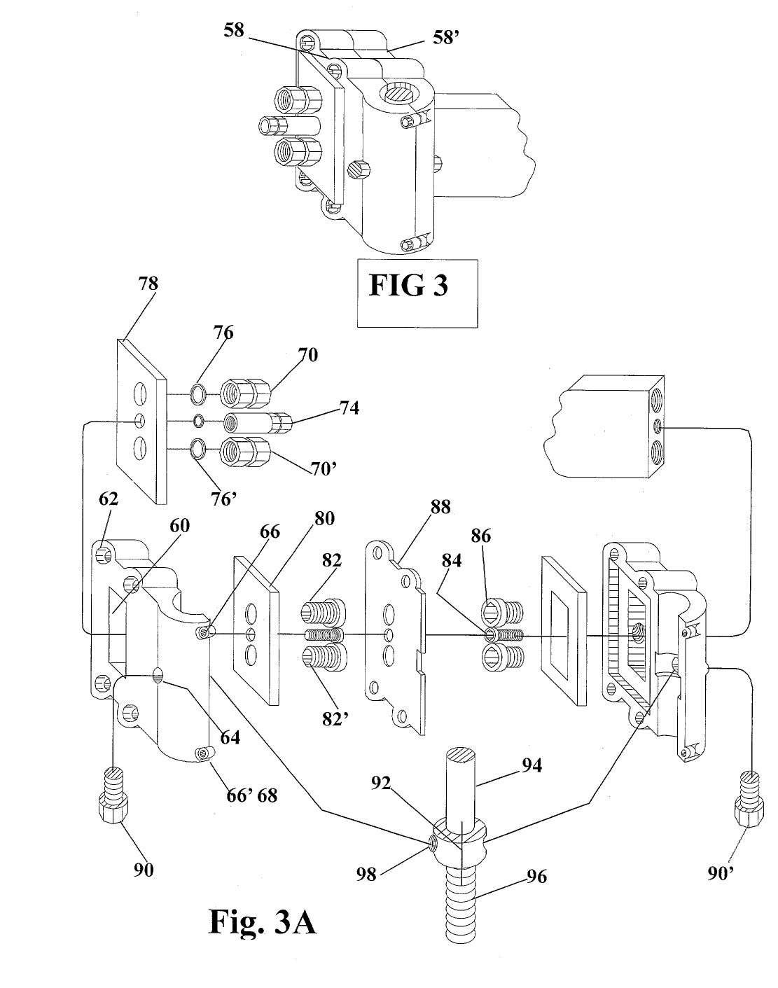

FIG. 5 is a perspective view of a double clamp illustrating the left bottom of FIG. 2;

FIG. 5A is a explode view illustrating an assembling sequence of FIG. 5;

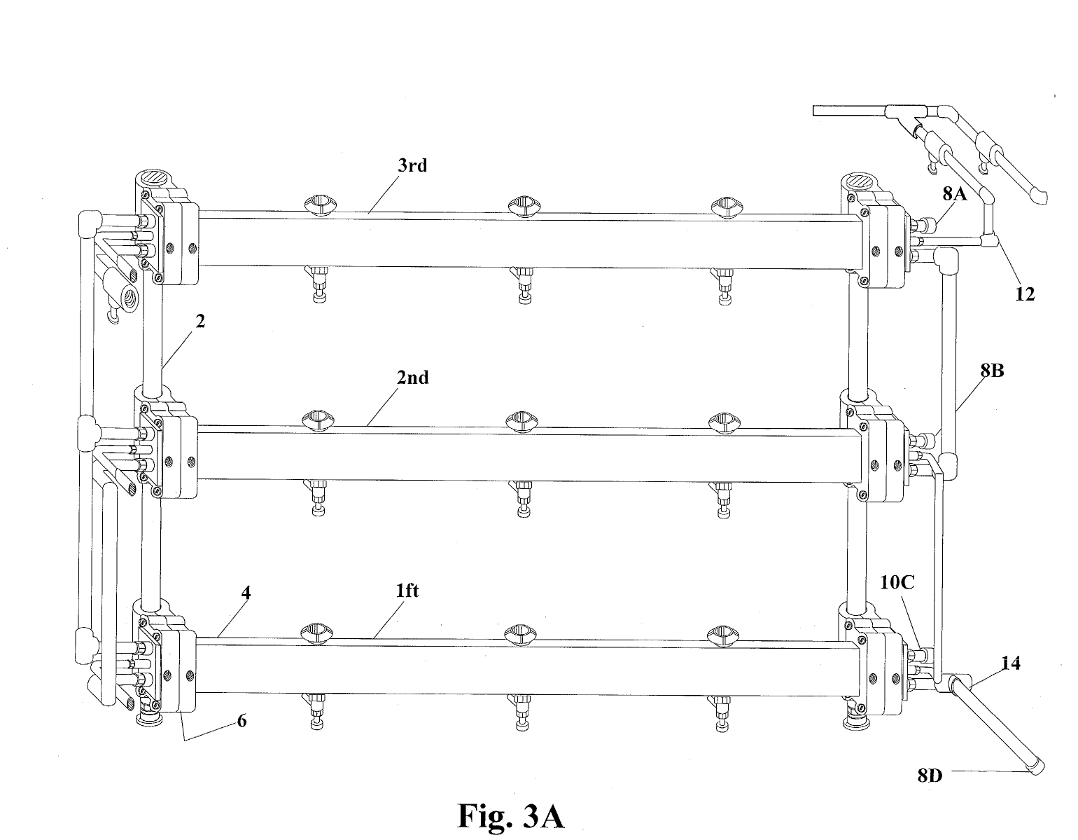

FIG. 6 is a perspective view illustrating the upper front double clamp of FIG. 3;

FIG. 6A is an explode view illustrating an assembling sequence of FIG. 6;

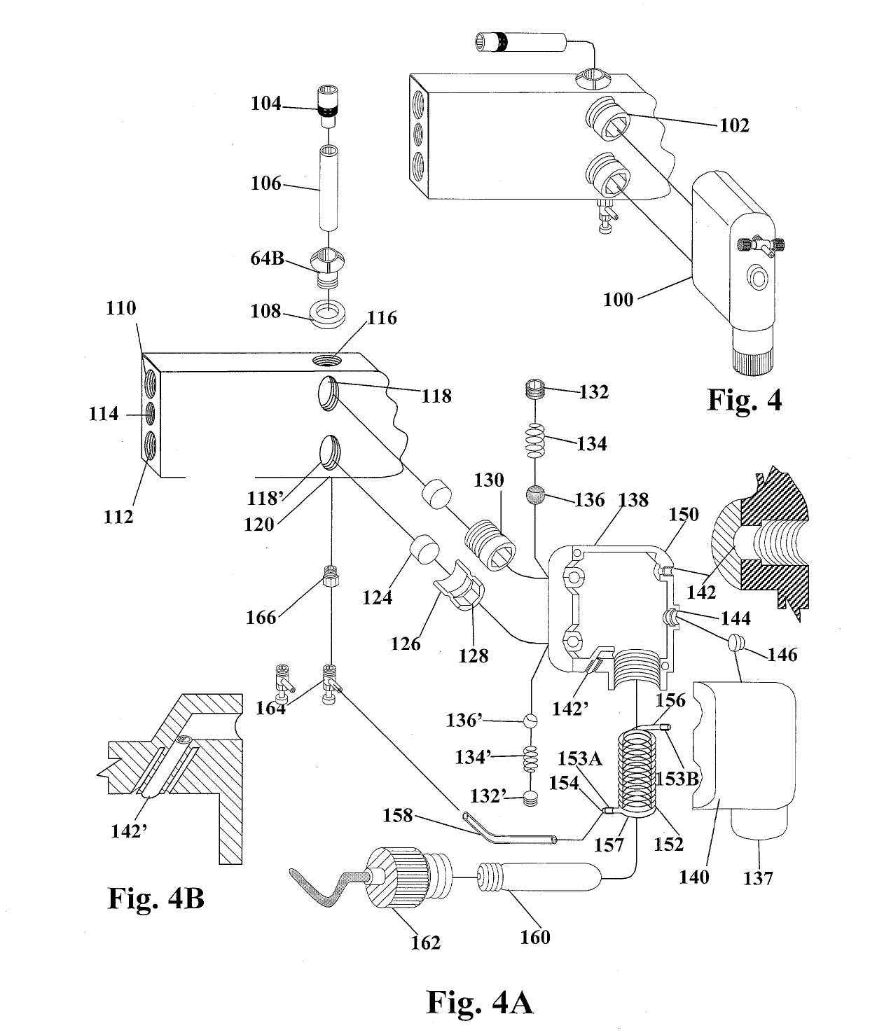

FIG. 7 is a perspective view of a portable UV lamp and a set of crystal installed to a three-way conduit, taking along the upper left front of FIG. 1;

FIG. 7A is an explode view illustrating an assembling sequence of FIG. 7;

FIG. 7B is an enlarge view of the left lower area of FIG. 7A illustrating a water inlet;

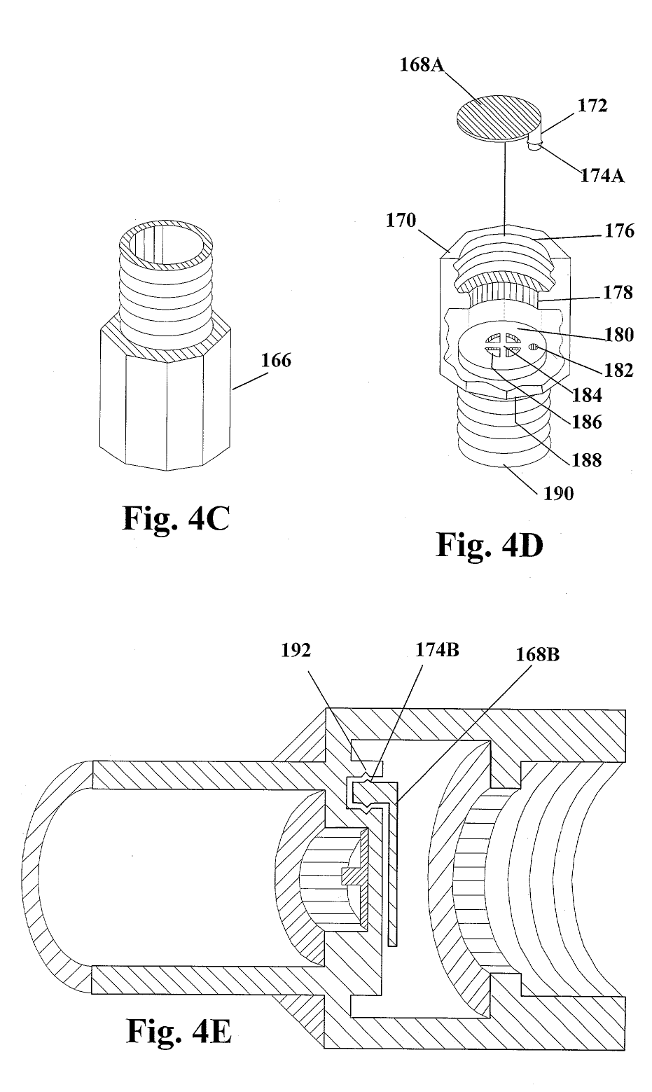

FIG. 8 is a perspective view of a valve adopter, for a ™Aquarium air valve;

FIG. 8A is a explode view illustrating bottom detail with broken area;

FIG. 8B is a perspective view illustrating center detail of FIG. 8;

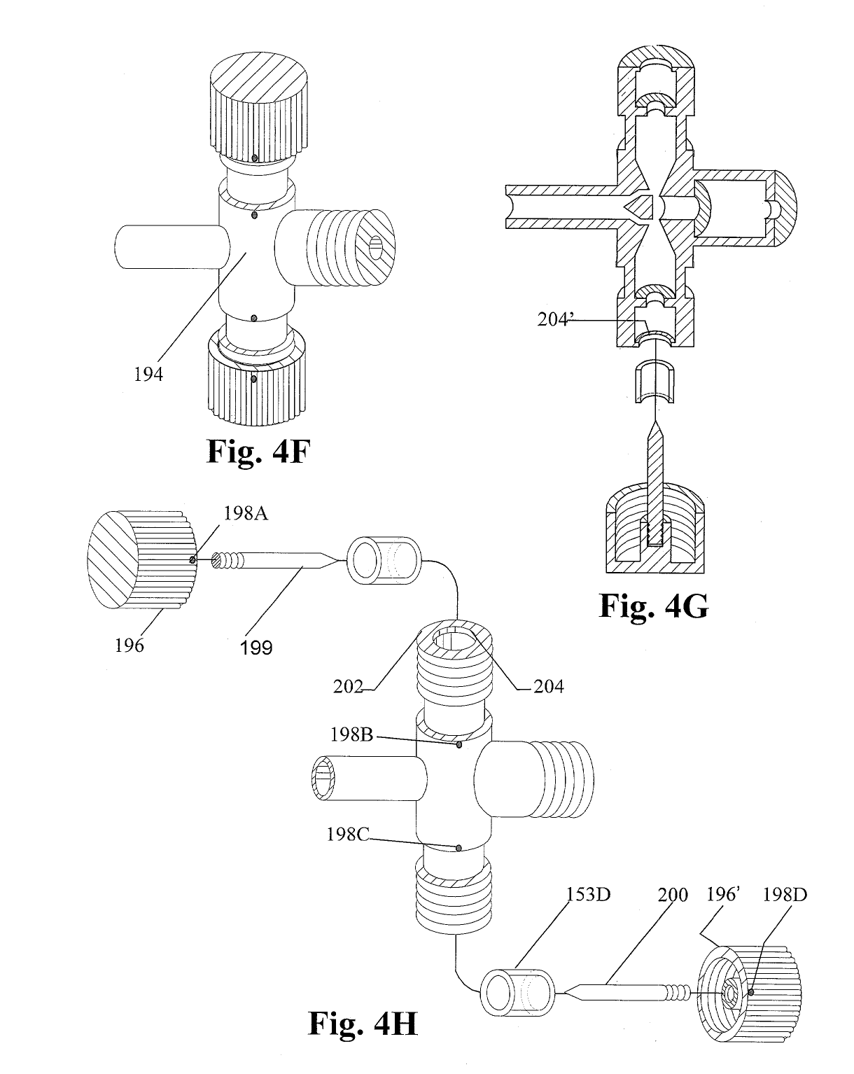

FIG. 9 is a perspective view of the upper front of FIG. 7 illustrating a double ion valve;

FIG. 9A is a center section of FIG. 9 illustrating inner details;

FIG. 9B is an explode view illustrating an assembling sequence of FIG. 9;

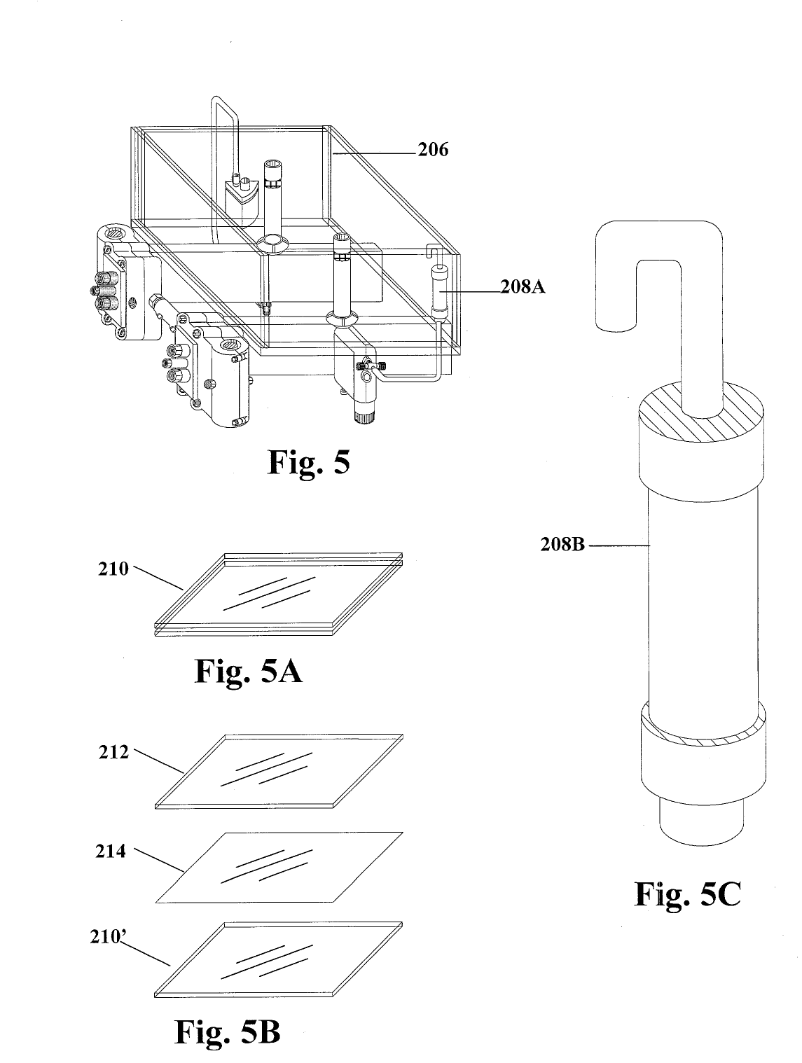

FIG. 10 is a perspective view of the top left portion of FIG. 1 illustrating the installation a self-photohygiene aquarium;

FIG. 10A is a perspective view of a portion of FIG. 10 illustrating a single hygiene glass

FIG. 10B is an explode view illustrating an assembling sequence of FIG. 10A;

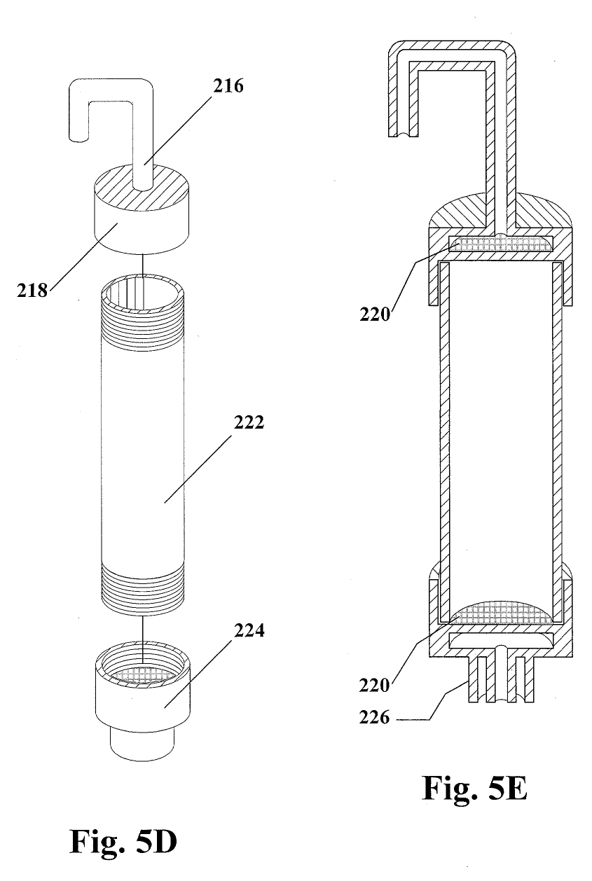

FIG. 11 is a perspective view of a portion of FIG. 10 illustrating a pH catalyst;

FIG. 11A is an explode illustrating an assembling sequence of FIG. 11;

FIG. 11B is an elevation center view illustrating inner detail of FIG. 11;

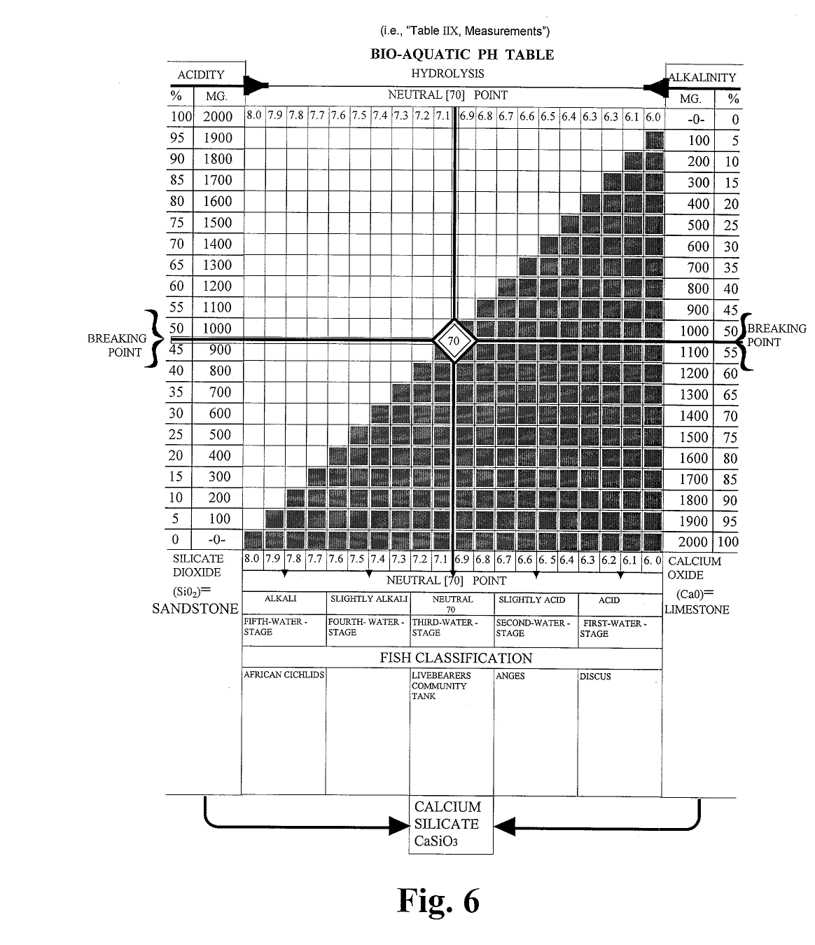

FIG. 12 is a view of a bio-aquatic pH table;

Reference Numeral

| | | |
|---|---|---|
| FIG. 2 | Air pump | 56A-Baquarium |
| | | etainer |
| 2 riser | Water heater | FIG. 6 |
| 4 three-way conduit | Optional Water pump | 58′, 58″ partial clamps |
| 4 or multiple conduit | age Water pump | 60 rectangular path |
| 6 double clamp | Wet/Dry vacuum | 62 octagonal hole |
| 1st-3rd level | 28 acclimate extension | 64 riser hole |
| 8A-D vacuum port | 30A hot acclimate | 66, 66′ knob |
| 12 hot water outlet | 30B cold acclimate | 68, 68′ holes |
| 14 airport | 30C optional acclimate | 70, upper swivel |
| FIG. 3 | 30D cold water inlet | 70′ lower swivel |
| 16 sewage-drainage | FIG. 5 | 74 center swivel |
| 17 recycling drainage | 32 clamp leg | 76,76′ rubber washer |
| 18A-E hot water | 34conduit holder | 78 outer plate |
| circulator | 38,40 screw and nut | 80 inner holder plate |
| 20 air/water circulator | 42 leg coupling | 82, 82′ retainer |
| 22 faucet | 44 octagon bottom | 84 center retainer |
| 24, 24′lower water | 46 swivel end cap | 86 octagon hole |
| circulator | 48, 48′ swivel | 88 rubber seal |
| FIG. 4 | 50, 50′ Allen screw | 90, 90′ riser screws |
| 26, 26′upper water | 52 perforated | 92 level retainer |
| circulator | 54 rubber plug | 94 riser stem |
| 96 leg stem | 140 male housing | FIG. 9 |
| 98 threaded hole | 142, 142′ core grooves | 194 double ion valve |
| FIG. 7 | 144, 144′ partial hole | 196, 196′ valve cap |
| 100 portable UV lamp | 146 glass crystal | 198A-D mark |
| | | indicator |
| 102 threaded crystal | 150 see-through | 199 oxidize tip |
| 104 plastic drainer | assembling holes | 200 ozonize tip |
| 106 plastic stem | 152 core | 202 valve housing |
| 108 silicon washer | 153A-D core seal | 204 seal edge retainer |
| 110 water conduit | 154 bottom connector | FIG. 10 |
| 112 air conduit | 156 top connector | 206 hygiene aquarium |
| 114 hot water conduit | 157 core hole | 208A-B pH catalyst |
| 116 threaded path | 158 flexible tubing | 210 hygienic glass |
| 118 magnetic field path | 160 light bulb | 212-212′ single glass |
| 118′ magnetic field | 162 electrical fixture | 214 silicon layer |
| 150 see-through | 164 Aquarium valve | FIG. 11 |
| assembling holes | 166A-B valve adopter | 216 top cap cover |
| 152 core | FIG. 8 | 218 protruded stem |
| 153A-D core seal | 168A-B flexible | 220 grain strainer |
| | rubber | |
| 154 bottom connector | 170 octagon housing | 222 canister |
| 156 top connector | 172 protruded stem | 224 bottom cap |
| path | 174A-B front knob | 226 tubing connector |
| 120 air outlet | 176 inner hole | |
| 124 cylindrical quartz | 178 edge | |
| 126 plastic casket | 180 retain plane | |
| 128 octagon shape | 182 cylindrical | |
| | insertion | |
| 130 retainer groove | 184 cross stopper | |
| 132, 132′ octagon screw | 186 semi-cylindrical | |
| | path | |
| 134, 134′ set of spring | 188 outer edge | |
| 136, 136′ sphere | 190 outer stem | |
| 137 partial stem | 192 knob groove | |
| 138 female housing | | |

### SUMMARY

Method and apparatus, for improving aerobe hydraulic photosterilization; thus, further improve ozonization, and synergistic radiation employing the following steps; ¹allow fish get used to habitat, ²auto-photo clean air/water lines, ³auto-photo periodic aquatic adapt stand, ⁴better photo sterilize air and water, ⁵making a constant illuminated conduit, ⁶photo transforms from air and water waste matter into ozone, ⁷night and daily photo nurture aquarium sick fish, ⁸extent time illumination of air/water, ⁹allow fast air/water to instant photo purify, ¹⁰improve ozonization and synergistic radiation, ¹¹photo expose air/water flow without touching the titanium dioxide coat, ¹²stops aquarium water and fish waste matter to fall into storage tank, ¹³generating auto-photo clean tank whereby, aquatic chemistry impedes nitrate accumulation, ¹⁴maximizing purification through “simultaneous exposure of ultraviolet and ozone”, ¹⁵impeding chlorinated water turning into chlorofluorocarbon, ¹⁶alternating light and Sol-gel reflection generating constant lunar-solar photoperiod, ¹⁷preventing Sol-gel coat been absorbed by the constant ozonated hydraulic stream, ¹⁸connecting one unit stand after the other repetitively forming a multiple unit stand, ¹⁹vacuuming the nitrate buildup from the series of air and water lines using granulated sodium chloride, ²⁰acclimating cold-blooded fish as well as warm-blooded, ²¹transmitting ultraviolet light distributed along the air and water stream, ²²eliminating nitrogen radical by bombarding biological filtration with assonated aeration, ²³preventing oxidant agent of ozone dissolve the titanium dioxide coat, ²⁴generating synergistic radiation employing minimum sunlight, ²⁵reversing the sunlight in the cycle of night providing a constant radiation for chlorine removal, ²⁶generating scattering cross-section, ²⁷regulate nitrates through the alternation of oxidation and ozonization, ²⁸generate and regulate reversible reaction between nitrate and ozone, ²⁹regulates aquarium pH through proportional adjusting of acidity and alkalinity, ³⁰exchange or alternate the flow of oxygen and ozone, ³¹employing technique that neutralizes chlorine water and fish waste among each other before settling in storage tank.

### PREFERRED—EMBODIMENT

This invention require certain Trade Mark (TM) accessories to operate, therefore devices names capitalized indicates a ™ apparatus.

FIG. 1 illustrates the present preferred embodiment of the invention, which is a stand unit to supports a series of ™ Aquariums. At the same time ¹allow fish, get used to habitat (acclimate aquatic lifeform to environment). In FIG. 2 further comprise a series of riser 2, and circulating tools such as a series of three-way conduit 4 (multiple conduit), and a series of double clam 6 (discuss In FIG. 3A). Thus, form a series of level 1^{st}-3^{rd} comprising a set of vacuum port 8A-D and 10A-D (10A-D shown in FIG. 4), a hot water outlet 12 and an air port 14.

FIG. 3 provides a ²auto-photo clean air/water lines (achieve self-photohygienic aerobe hydraulic conduits) comprising a sewage-drainage 16, and a recycling drainage 17. Further, comprise a series of hot water circulator 18A-E, (D and E shown in FIG. 4) an air/water circulator 20 with ™ Faucet 22, and a set of lower water circulator 24, 24′.

FIG. 4 illustrate a series of ™ devices such as an Air pump, a Water heater with an optional hot Water pump, an age Water pump and a Wet/Dry Vacuum. Further comprises a set of upper water circulator 26, 26′, an acclimate extension 28 accompanied by a hot acclimate 30A, a cold acclimate 30B, an optional acclimate 30C, and a main cold water inlet 30D.

FIG. 5 comprises a clamp leg 32 and a conduit holder 34 discussed in FIG. 5A, which comprise a series of screw 38 and nut 40. The clamp leg 32 consists of a leg coupling 42, having an octagon bottom 44 attached to a swivel end cap 46. The conduit holder 34 consists of a set of swivel 48, 48′, held by a set of Allen screw 50, 50′ within a perforated coupling 52. FIG. 5A further illustrates portions of the three-way conduit 4 accompanied by a rubber plug 54 and an aquarium retainer 56A.

FIG. 6 in which the double clamp 6 comes constructed of non-toxic material preferable anodized aluminum. The double clamp 6 comprises a set of partial clamp 58, 58′, and in FIG. 6A having a rectangular path 60, a series of octagonal hole 62, a riser hole 64, a set of knob 66, 66′ (does no show) with holes 68-68′. The clamp 6 assembling sequence comprises a set of upper/lower swivel 70, 70′, a center swivel 74, a series of rubber washer 76. Further comprise an outer plate 78, an inner plate 80, a double set of upper/lower retainer 82, 82′, a center retainer 84 having octagon hole 86. Further, comprise a rubber seal 88, a set of riser screw 90, 90′, a threaded level retainer 92 and a non-threaded level retainer (do not show).

The threaded level retainer 92 having a riser stem 94, a leg stem 96, and a threaded hole 98 to retain the levels 1^{st}-3^{rd} established in FIG. 2 according to the length of the riser 2. All retainers 82-82′ having octagon hole to come driven with an Allen wrench into the set of upper/lower swivel 70, 70′, so that retain the partial clamps 58,58′. Once completing the partial clamp 58 it may come duplicated, and fasten to its original forming the double clamp 6, and the double clamp 6 interconnecting with the three-way conduit 4 forms a nine-tank unit. Reassure that every other unit contains the level retainer 92 held by the riser screws 90.

Continue accommodating the risers 2, and the level retainer 92 to second, and third level of the unit (shown in FIG. 2). Direct the threaded leg stem 96 of the retainer 92 to the floor, so that come able to screw the clamp leg 32. Once having legs in place; apply a ™ Leveler device to level all the nine-tank units by adjusting legs 32 according to height and floor declination. Place the first nine-tank unit to desire position; apply graphic-gel to the inner holder plate 80 in every partial clamp of the unit; then accommodate the rubber seal 88. Apply the graphic-gel in the same manner to the second nine-tank unit in position, and couple it to the first one employing the series of assembling screw 38, and the other riser screw 90′. Reassure that when tighten the series of screw apply even pressure, so that the rubber seal 88 constrict evenly.

FIG. 7 generates a ³auto-photo periodic aquatic adapt stand (self-photoperiodic acclimatization aquatic pedestal). In FIG. 7A further comprises a portable UV lamp 100, and a series of threaded crystal 102 install to the three-way conduit 4 (multiple conduit). The three-way conduit 4 and the portable UV lamp 100 constructed of anodized aluminum generating an oxide surface later coated in glazed TiO₂.

FIG. 7A comprises a plastic drainer 104, a plastic stem 106 a duplicate of the aquarium retainer 56B and a silicon washer 108. The three-way conduits 4 having a water conduit 110, an air conduit 112, and a hot water conduit 114 all threaded about ¾″ deep. Further having, a threaded path 116, a set of magnetic field path 118-118′, and an air outlet 120 line up with the portable UV lamp 100. The threaded crystal 102 assembling sequence comprises a set of cylindrical quartz 124 and a plastic casket 126 having an inner octagon shape 128 and a retainer groove 130.

In FIG. 7A, the portable UV lamp 100 further comprises a set of octagon screw 132, 132′ a set of spring 134, 134′, and a set of sphere 136, 136. The lamp 100 has a threaded partial stem 137 a female housing 138, and a male 140 housing. Both housing having a set of core grooves 142, 142′ a set of partial hole 144, 144′ (144′ do not show) to insert a glass crystal 146. The female housing 138 have a series of threaded holes (do not show), and the male housing 140 have a series of see-through assembling holes 150.

FIG. 7A, the portable UV lamp 100 further comprises a core 152 accompanied by a set of rubber seal 153A, 153B. The core 152 consists of a thin glass tube wrap around forming a bottom connector 154, a top connector 156, and a core hole 157. The core hole 157 receives a light bulb 160 screwed to an electrical fixture 162. The portable UV lamp 100; also, requires a ™ Flexible tubing 158, an Aquarium valve 164, and a valve adopter 166 further discuss in FIG. 8, A-B.

Further, with reference to FIG. 7, in which the portable UV lamp 100 completes the ³auto-photo periodic aquatic adapt stand. (self-photoperiodic acclimatization aquatic pedestal). Thus, ⁴better photo sterilize air and water (improving aerobe hydraulic photosterilization). The solar light passes through the cylindrical quartz 124 increasing ultraviolet radiation. Thus, ⁶photo transforms from air and water waste matter into ozone (photosynthesize aerobe hydraulic effluent generating ozonization). The portable UV lamp 100 and threaded crystal 102 ⁷night and daily photo nurture aquarium sick fish (photoperiodic incubate subject to disease aquatic lifeform). This is possible by allowing the Sol-gel conduits to absorb light during the day generating a twelve-hour interval of solar photoperiod. While at night the Sol-gel reverses the light absorbed generating another twelve-hour of lunar (Moon) photoperiod; thus, maintain fish under normal condition. Although the apparatus also, ⁷photo constantly nurture aquarium sick fish (photocontinuum incubate subject to disease aquatic lifeform), under abnormal conditions. This is possible by allowing the UV lamp 100 illuminate the Sol-gel conduits constantly until fish illness disappears. This is possible because the core ⁸extent time to further illuminate the water (prolong photo exposure among substances). Thus allows ⁹fast air/water to instant photo purify (access abrupt aerobe hydraulic effluent assimilates immediate photosterilization). The anodize coat provides an oxide surface, which works as an adhesive, for another inner coat of glazed titanium dioxide (TiO₂ or Sol-gel).

The titanium dioxide absorbs solar energy and reverses it at night ⁵making a constant illuminated conduit (creating continuous magnetic field conductivity). Thus, generate a pattern of colors (lattice) that ¹⁰improve ozonization and synergistic radiation. The core 152 and the glaze coat ¹¹photo expose air/water flow without touching the titanium dioxide coat (photoexpose aerobe hydraulic stream impeding Sol-gel physical contact) of the portable lamp 100 and conduits. The valve adopter 166 ¹²stops aquarium water and fish waste matter to fall into storage tank (prevent hydraulic and organic effluent descent into reservoir). The double ion valve 194 exchange, or alternates the flow of oxygen and ozone.

FIG. 8A, the valve 166 comprises a flexible rubber 168A, and an octagon housing 170. The flexible rubber 168 has a protruded stem 172 with a front knob 174A. The octagon housing 170 having an inner hole 176 threaded about ⅜ of an inch deep ending in an edge 178. Furthermore, having a flow retain plane 180 a cylindrical insertion 182 a, cross stopper 184, forming a series of semi-cylindrical path 186, an outer edge 188, and a threaded outer stem 190. In FIG. 8B, an enlargement of the octagon housing 170 further illustrates a knob groove 192 to retain the rubber 168 knob 174B. The outer stem 190 comes threaded about ⅜ of an inch to couple the ™ Aquarium valve 164.

FIG. 9 illustrates a double ion valve 194 comprising a set of valve cap 196, 196′ having a series of mark indicators 198A-D, an oxidize tip 199, and a ozonize tip 200. The tips 199-200 accompanied by the set of rubber seal 153C-D established in FIG. 7A. Further comprise a valve housing 202 having a set of seal edge retainer 204,204′, and similar marks indicator 198B-C. The entire valve 194 comes construct of plastic except the oxidize tip199 which is made out of copper.

Referring to FIG. 10 in which, comprise a ¹³auto photo-clean tank 206 (self-photohygiene aquarium) and a pH catalyst 208A. In FIG. 10A further comprise a photo hygienic glass 210, and in FIG. 10B comprises a set of single glass 212-212′, and a silicon layer 214; forming a glass silicon sandwich. The photo hygienic glass 210 further arranged in a rectangular manner forms the ¹³auto photo-clean tank 206 (self-photohygiene aquarium). When light passes; through the silicon layer 214 produces ultraviolet radiation (UV). The UV generates a magnetic field upon the glass; whereby aquatic chemistry impedes nitrate accumulation as follows.

### EXAMPLE 1

UV+Si+NO₃>N+O₃

During night (dark reaction) period fish impurities attaches to the glass in form of nitrate (NO₃). During day (light reaction) period the UV ray decomposes the NO₃ producing nitrogen (N) and ozone (O₃). The O₃ reacts with fish impurities producing ordinary oxygen (O₂) and atomic oxygen (O). The ordinary oxygen comes breathed by fish while the atomic oxygen waits for night period, and reacts with fish impurities to start the nitrate cycle again. This kind of chemical behavior ²⁸generates a reversible reaction between nitrate and ozone, ¹⁴maximizing the purification through “simultaneous exposure of ultraviolet and ozone.”

Referring to FIG. 11 in which, FIG. 11A-B comprise a protruded stem 216 with a top cap cover 218, and a build in grain strainer 220. Further, comprise a canister 222 a bottom cap 224 having similar grain strainer 220, and a tubing connector 226. The canister comes fill with equal portions of natural ore such as sandstone (SiO₂ acid) and limestone (CaO alkaline) to produce neutral pH or calcium silicate (CaSiO3).

FIG. 12 is a view of a bio-aquatic pH table (i.e., “Table IIX, Measurements”) to measure the natural ore acid and alkaline (hydrolysis) in parts per million (PPM). Namely, when using anhydride (powder) although 1.4 pound per gallon when using the natural ore as decorated gravel for balancing the pH according to biological filtration. The table shows a graph that rises at forty-five degrees from bottom left to right. Each end of this graph immerses into a pH table adapted from the standard pH system. The standard pH system was broken into fractions; thus, determine the save pH zone from 6.0—8.0 to keep live tropical fish. The graph comes accompanied with vertical, and horizontal bold lines centralized with a diagonal frame determining the neutral points (70). The horizontal bold line indicates the breaking points that fluctuate the water hydrolysis in quantities equal one fraction of a pH degree per square equivalent to 100 milligrams. On both sides of the bio-aquatic pH table (i.e., “Table IIX, Measurements”) indicated by the breaking points, whereupon, the table adapts the standard pH system neutral point. At this point, each side of the table has pH value equivalent to one gram; converted in milligrams to achieve measuring the pH ions in fraction. This concentration of pH ions is the digital description shown under column marked milligrams (MG.) that increase at one hundred milligrams per square. The acidity or white squares indicate the positive (+) pH ions of silicate dioxide (SIO₂), and the alkalinity or dark squares indicate the negative (−) pH ions of calcium oxide (CAO). Therefore, the propose chemicals balance the pH as well as the biological filtration (see book report under Bio-Aquatic pH Table).

### PREFERRED EMBODIMENT—OPERATION

Operation of the device of the present invention will be described further with reference to FIG. 7.

As indicated in FIG. 2 in which, ¹acclimate aquatic lifeform to environment; thus, comprise a series of riser 2, and circulating tools consisting of a series of multiple conduit 4 and a series of double clamp 6. These circulating tools generate a series of level 1^{st}-3^{rd} comprising a double series of vacuum port 8A-D-10A-D a hot water outlet 12 and an air port 14.

As indicated in FIG. 3 in which, generates a ²self-photohygienic aerobe hydraulic conduits comprising a recycling drainage 16 and a sewage drainer 17. The circulating tools further comprise a series of hot water circulator 18A-E, an air/water circulator 20 with a ™ Faucet 22, and a set of lower water circulator 24, 24′.

As indicated in FIG. 4 in which, FIG. 4 further illustrate a series of ™ devices such as an Air pump, a Water heater with optional hot Water pump and a Wet/Dry Vacuum. The circulating tools further comprise a set of upper water circulator 26, 26′, a acclimate extension 28 accompanied by a series of hot/cold Faucet. These faucets comprise a hot acclimate 30A, a cold acclimate 30B, an optional acclimate 30C, and a main cold water inlet 30D. As indicated in FIG. 7, 7A-B in which, ³generate a self-photoperiodic acclimatization aquatic pedestal. Thus, comprise a portable UV lamp 100 and a series of threaded crystal 102 install to the multiple conduit 4. The multiple conduits 4 and the portable UV lamp 100 constructed of anodized aluminum; thus, generate an oxide surface later coated in glazed titanium dioxide (TiO₂). The series of threaded crystal 102 have a set of cylindrical quartz 124 and in a plastic casket 126 having an inner octagon shape 128 and a retainer groove 130 couple to the portable UV lamp 100. The portable UV lamp 100 further comprises a set of rubber seal 153A, 153B and a core 152. The 152 core consisting of a thin glass tube wrap around forming a bottom connector 154, a top connector 156, and a core hole 157. The core hole 157 receives a light bulb 160 screwed to an electrical fixture 162. The portable UV lamp 100; also, requires a ™ Flexible tubing 158, an Aquarium valve 164, and a valve adopter 166. The valve adopter 166 comprises a flexible rubber 168 and an octagon housing 170 connected to the multiple conduits generating support for a series of Aquarium.

As indicated in FIG. 10 and 10A-B in which, FIG. 10 comprise a ¹³self-photohygiene aquarium 206. Further comprising a photohygienic glass 210, a set of single glass 212-212′, and a silicon layer 214. The photohygienic glass arranged in a rectangular manner generates the self-photohygiene aquarium 206.

### THEORY

Titanium is the ninth most abundant element, comprising about 0.63% of the Earth's crust. Analyses of rock samples from the Moon indicate titanium is far more abundant there; some rocks consisted of 12% titanium by weight. The most important titanium minerals are anatase, brookite, and rutile, all forms of titanium dioxide, which, is a white substance with a high reflective power. Although the, Moon do not produce radiation on its own. However, the reflection of the Moon is attribute to the abundance of titanium dioxide there. That absorbs radiation from self-illuminated interplanetary objects, but mainly from the Sun. The Moon radiation has immense power over Earth. Thus, determines weather patterns by transforming atmospheric nitrogen into oxygen forming negative (−) charge clouds. These clouds react with other positive (+) charge of hydrogen clouds causing the weather pattern to produce rain. The Moon radiation; also, controls Ocean ties, and is to believe that intervene in animal and plants growth even affect complex human psychological profiled. This condition is mostly noticeable in the period of Full Moon; therefore, Moon radiation, or titanium dioxide reflection is very important, for the growth harmonization of animal and plants. Science has discover that a thin reflecting layer of titanium dioxide applied by a process known as Sol-gel; prevents solar radiation (UV light) from turning chlorine into chlorofluorocarbon. Therefore, using radiation as the ultimate option, for correcting the physiological and psychological problem that aquatic life meet today. The radiation must be employ as a simultaneous photoperiod. Therefore, combining the Moon and Sun (lunar-solar) illumination generates a double lattice (light pattern) constituting a bi-spectral synergistic radiation (full-spectrum). Therefore, the apparatus employ lunar-solar radiation in a steady exposure when the stated portable UV lamp is constantly on the Sol-Gel. This ⁵creates continuous magnetic field conductivity within the conduits in which, the lunar-solar photoperiod do not diminish from 12 hour interval to zero as in Nature. Therefore, as the portable UV lamp is on, the apparatus achieves properties; able to ⁷photocontinuum incubate subject to disease aquatic forms. I called these properties the photocontinuum frequency in which; animals disordered immunology photo equilibrates. This is possible by simulating the Moon radiation with the Sol-gel technique, and ²⁷performing minimum alternation of light and Sol-gel reflection. This generates a constant lunar-solar photoperiod. Thus, allows the Sol-gel, or Moon radiation to travel through the ³Self-photoperiodic Acclimatization Aquatic Pedestal. The pedestal distributes the lunar-solar photoperiod along the air and water stream; thus, generate a ²self-photohygienic aerobe hydraulic conduits. That ⁶photosynthesize substance generating ozonization ¹⁴while maximize purification through “simultaneous exposure of ultraviolet and ozone”. The ²¹ozone eliminate nitrogen radical by bombarding biological filtration with ozonated aeration. The minute this ozonated aeration meets aquarium nitrates, or nitrogen compounds it turns into oxygen in the same manner as Nature according to example 1. ⁴Improving aerobe hydraulic photosterilization ¹to acclimate aquatic lifeform to environment.

### CONCLUSIONS, RAMIFICATIONS, AND SCOPE

Thus, the reader will see that I have provided a method and apparatus, for ⁴improving aerobe hydraulic photosterilization, and acclimate aquatic life to environment as summarize below: ¹acclimate aquatic lifeform to environment; ²self-photohygienic aerobe hydraulic conduits; ³generate a self-photoperiodic acclimatization aquatic pedestal; ⁴improve aerobe hydraulic photosterilization; ⁵create continuous magnetic field conductivity; ⁶photosynthesize aerobe hydraulic effluent generating ozonization; ⁷photoperiodic and photocontinuum incubate subject to disease aquatic lifeforms; ⁸prolong photoexposure among substances; ⁹access abrupt aerobe hydraulic effluent assimilates immediate photosterilization; ¹⁰improve ozonization and synergistic radiation; ¹¹photoexpose hydraulic stream impeding physical contact; ¹²prevent hydraulic and organic effluent descent into reservoir, ¹³self-photohygienic aquarium whereby aquatic chemistry impedes nitrate accumulation; ¹⁴maximizes purification through “simultaneous exposure of ultraviolet and ozone”; ¹⁵impede chlorinated water turning into chlorofluorocarbon; ¹⁶alternate light and Sol-gel reflection generating an constant lunar-solar photoperiod, ¹⁷preventes Sol-gel coat been absorbed by the constant ozonated hydraulic stream; ¹⁸connects one unit stand after the other repetitively forming a multiple unit stand; ¹⁹vacuums the nitrate buildup from the series of air and water lines using granulated sodium chloride; ²⁰acclimate cold-blooded fish as well as warm-blooded; ²¹eliminate nitrogen radical by bombarding biological filtration with assonated aeration; ²²transmitt ultraviolet light distributed along the air and water stream; ²³prevents oxidant agent of ozone dissolve the titanium dioxide coat; ²⁴generate synergistic radiation employing minimum sunlight; ²⁵reverses the sunlight in the cycle of night providing a constant radiation for chlorine removal; ²⁶generate scattering cross-section; ²⁷regulates nitrates through the alternation of oxidation and ozonization; ²⁸generate and regulates reversible reaction between nitrate and ozone; ²⁹regulate aquarium pH through proportional adjusting of acidity and alkalinity; ³⁰exchange the flow of oxygen and ozone; ³¹employ technique that neutralize chlorine water and fish waste among each other before settling into storage tank.

Although the description above contains much specificity, these should not be construed as limiting the scope of the invention, but as merely providing illustrations of some of the presently preferred embodiments of this invention. For example, the three-way conduit (multiple conduit) may come construed regular stand. That means, without the installation of crystals, Sol-gel, and glass coats to generate a plain multiple conduits. Thus, the apparatus may come called Multiple Aquarium Stand, which may come connected to any ™ Ultraviolet Aquatic System. Preferable the prior art Aerobe Hydraulic Photosterilization, which allows the stand to perform equally as The ³Self-Photoperiodic Acclimatization Aquatic Pedestal. The apparatus is a nine-tank unit that ¹⁸connect one after the other; consecutively, forming a multiple unit stand. This is possible by constructing the nine-tank unit with the partial clamp build as indicated in FIG. 6. However, you can make adjustment for the length of risers, three-way conduit, and the perforated coupling according to the size of tank. The unit may also, employ an unstated vacuum coupling to adopt a ™ Wet/Dry Vacuum to service, or clean the air/water lines periodically when employing the plain multiple conduits. This is possible by mounting the vacuum coupling to the bottom of the 198 Vacuum forming an outtake port, besides the original Vacuum intake port. Connect the outtake port to the airline and the original port to the water line as illustrated in FIG. 4. Turn off the water/air pumps and open the Faucet (22). This allows the circulation to ¹⁹vacuum the nitrate buildup from the series of air and water lines using granulated sodium chloride (salt). However, the nitrate buildup will come considerably reduce. By installing along the three-way conduit, a set of unstated continuous elongated quartz crystals instead of the established threaded crystals. The Vacuum may also, salt flush the back, and front drainage; individually, by connecting the ™ Vacuum outtake to the vacuum port 8B of the stand. Then, keep moving the ™ Vacuum intake among port 8A and 8C, which flushes the back of the stand. Apply the same process to flush the front of the stand dealing with vacuum ports 10A-C shown FIG. 4. When using the plain multiple conduits; the stand should be clean at least every four-months together with the main biological filter, which should come water back-flushed every week; even if connected to the prior art Aerobe Hydraulic Photosterilization. When using the apparatus clean the main biological filter at the same month period of the prior art. The stand should come clean once every year if employing the threaded crystal, but if using the unstated elongated crystals clean the stand conduits every two years. The apparatus may ²⁰acclimate cold-blooded fish as well as warm-blooded. When acclimating using an open cycle mode, meaning that the hot or cold water; also run into the system to top the aquarium level. Therefore, during this open cycle leave the last tank empty, and turn on the cold or hot water acclimates, which ever the case may be. Allow the water to run throughout the recycling drainage (17). This permits the water to travel through the Sol-gel photo-dechlorination process. Therefore, by the time the chlorine water settle in an unstated aquatic reservoir is completely dechlorinated. This form of dechlorination; also, work as a germicidal among fish waste; since, the recycling drainage runs in combine with the chlorine water into the storage tank. Therefore, the apparatus employs a technique that neutralizes chlorine water and fish waste among each other. In this case, allow the chlorine water and fish waste to mix in an unstated prior-storage tank, for better neutralization. This form of neutralization is appropriate, for acclimating cold-blooded fish. Another way, for acclimating is by using a close cycle mode. In this mode, substances come compressed within the centerline of the three-way conduit. Then, recycle among the series of multiple stands generating a heat exchange, for hot-blooded fish, and cold exchange for cold-blooded. The closed cycle acclimate cold-blooded fish by substituting the Water heater with a ™ Refrigeration system. In this case, close hot/cold water acclimates 30A-B, or simply do not perform these connections. The great advantage is that the conductivity of chill, or heated water does not require huge conduits since the substance come pressurized in the close cycle; therefore, a ½″ conduit is sufficient. However, dealing with this kind of system must employ a license technician to do the job. Because refrigeration has gaseous properties, (chlorofluorocarbons) that may leak into the environment, but mainly into the air/water lines causing ozone depletion. Another advice, the water part of the close cycle must be on constantly; otherwise, ice migrates to the water line slowing down flow. On the other hand, to use the close cycle to acclimate hot-blooded fish close acclimate 30A, B, D, open C, and connect the optional hot Water pump to the Water heater. Although to prevent liquid drought in the aquariums system, connect an unstated cold water faucet equally in size to the acclimate extension 28 established in FIG. 4. The applicant recommends the close cycle system because the acclimatization comes from the condensation and saturation produced by the heat exchange process. In which the compressed substances do not leak into the reservoir tank. Thus, prevents the reservoir tank to come segregated with toxic iron oxide from an ordinary boiler or water heater. Therefore, when adding water to top the aquariums use age water (that is, water that has been aerated in room temperature for at least three days) instead of hot water. Otherwise, Make sure, that water addition passes through the technique that neutralizes chlorine water and fish waste among each other, that is, if using chlorine water. Apply the same technique using the open cycle, for the addition of hot water, but reassure that the heating source employed is constructed of non-toxic materials such as plastic and glazed steel. There is an economical acclimate mode, that the applicant calls the universal mode because it works with the settings of previous modes. In this case, has to be a situation where the aquatic system is located below a residential complex. A proportional percentage of the complex close cycle acclimating system connects direct to the multiple stand before reaching apartments, so when tenants open their radiator the close cycle also acclimate aquariums. However, in a general integrated air condition system, the chill gases are handle in the same manner. Although, remember that the water recycle, for fish keeping must be kept constantly running to prevent migration of ice within water lines. When using cold, or hot water as the raw material, for acclimatization the apparatus work in the same manner. That is when the tenants open their faucets (open cycle) the close cycle acclimates aquariums water within conduits

In this case, the apparatus do not require additional pump to propel the acclimating substances. The quart crystal ²¹transmit ultraviolet light; distributed along the air/water stream utilizing minimum sunlight generating ozone. The hot or chill stream connects direct to aquarium corner-filter, so that ²²eliminate nitrogen radical by bombarding biological filtration with azonated aeration. There is no specific number of crystal insertions in the conduits; however, larger number greater is the ultraviolet transmission. However, if installing the threaded crystal regardless of the order, must provide at least a set precisely, in line with aquarium retainer and Air valve. The UV transmitter crystal may also, come construct of clear silicon rubber, or silicon plastic. Even if, the material chosen to generate conduit transparency is not a UV transmitter media; the Sol-gel coated conduit still remove chlorine from the water; since, the Sol-gel reflection generate a light pattern (lattice) equivalent to a full spectrum. When using, the UV transmitter media the conduits may acquire a glaze coat; ²³to prevent the oxidant agent of ozone dissolve the titanium dioxide coating (Sol-gel process). The entire apparatus must attain an anodized coating to strengthen the aluminum and obtain an adhesive oxide surface, for better application of the Sol-gel process. The application of titanium dioxide and anodizing processes are not part of the invention. This method is known as Sol-gel technique, will be effective. See for example, “Use of Sol-gel Thin films in Solar Energy Applications” by R V Petite et al. Solar Energy Materials volume 14, PP 269-287,1986, Elsevier Science Publishers B. V.-North Holland Physics Publishing Division Amsterdam. The installation of crystal and the Sol-gel process create a sensitive environment to ²⁴generate synergistic radiation employing minimum sunlight. This advantage relies on the Sol-gel process, which ²⁵reverses the sunlight in the cycle of night providing a constant radiation for chlorine removal. Thus, the scope of the applicant, this advantage takes in consideration limiting the use of UV lamp and UV monitoring device. Because the apparatus has the Nature's solar photoperiod in which, the Sol-gel absorbs UV radiation during daytime, so that releases illumination at night. At this, point the photo-dechlorination is at the peak of performance. Therefore, applicant advice that the addition of chlorine water, for acclimating cold, and hot-blooded fish must come added during the lunar cycle (at night). The core may work as a retroreflecting prism ²⁶generating a scattering cross-section; thus forces the UV radiation among the water molecule nucleus instead of scattering within the portable lamp. The multiple conduit installation of threaded crystals; also, generate a scattering cross-section. The oxidize tip of the double ion valve may come construct of copper or the like. The oxidize tip decreases the ozone flow in the aquarium when acclimating species that like nitrate water. In others words the oxidize tip increases the level of nitrate. Therefore the oxidize tip was designed to provide an aquatic habitat, for specie such as betta fish, gurami, or any bubble-ness species. On the other hand, the ozonize tip come construct of plastic or carbon which, have the opposite function of the oxidize tip. The ozonize tip increases the ozone flow in the aquarium to acclimate species that do not like nitrate water. In others words the ozonize tip decreases the level of nitrate. Therefore the ozonize tip was designed to provide an aquatic habitat, for specie such as angels, discus and tetra. Considering the pH level the ozonize tip may; also, come usefully to acclimate African cichlids and livebearers (later discussed by the pH catalyst). Therefore the double ion valve ²⁷regulates nitrates through the alternation of oxidation and ozonization (oxide and ozone). The same nitrate regulation occurs by the self-photohygiene aquarium which, ²⁸generate and regulates reversible reaction between nitrate and ozone as indicated in example 1. However, the self-photohygiene aquarium may; also, come constructed of quartz glass, which, do not require a silicone layer to generate ultraviolet ray. The pH catalyst will regulate impurities by balancing the fish pH with the water pH. This is possible by separating the natural ore in two catalysts per tank, one with acid and the other with alkaline. In this case, an unstated double pH catalyst, and an aquarium tubing splitter is necessary to bi-deviate the water current from the double ion valve into each pH catalyst. The same result comes accomplished by simply designing the double ion valve with a set of water outlet. The same process may come accomplished by designing an unstated catalyst hanger, able to support at least a set of pH catalyst. These last setting may acclimate livebearers and African cichlids by adjusting the ions of each pH catalyst according to fish pH. Therefore, the double ion valve ²⁹regulates aquarium pH through proportional adjusting of acidity and alkalinity ³⁰as simultaneously alternate the flow of oxygen and ozone. Consider consulting the Bio-Aquatic pH table (i.e., “Table IIX, Measurements”) to balance the desire pH according to the biological filtration, using different structural form of the propose chemical. For example, lets balance the pH of 6.8 according to the biological filtration in a ten-gallon of water. On the acid column of the Bio-Aquatic pH table generate 7.7 pounds of sandstones, and in the alkaline column generate 6.3 pounds of limestone. On the other hand, using the anhydride, or powder form of the chemical only requires; (one part per million 1PPM) eleven hundred milligrams on the acid column, nine hundred milligrams on the alkaline column. The following array of compounds is set to produce neutral pH. For example, in a power filter (P.F.), use one once per gallon in equal proportion of sandstone and limestone grains to balance pH according to the biological filtration. In this case, use 1/16 of an inch grains, distribute the grains among three pool filter if sterilizing at least 26 thousands gallons of water. Employ the first pool filter to propel the water to the aquariums; use the second pool filter to recycle the water in the unstated reservoir; apply the third pool filter to mix the top water with fish recycle wastewater. This last option makes it possible to ³¹employs the technique that neutralizes chlorine water and fish waste among each other before settling into the reservoir. In powder, use one part per million (1PPM) of calcium silicate (CaSiO₃). In natural filtration (N.F.), use one pound per gallon if employing 3/16 of an inch grains, or natural ore as decorating gravel, but if employing ⅜ of an inch ore use 1.4 pounds per gallon. Consult for more information the biological filtration column (i.e., “Table IV, Measurements”) of the elements scale attached to the end of the book report. Thus the scope of the invention should be determined by the appended claims, and their legal equivalents, rather than by the examples given.

What I claim is:

1. The method of acclimating aquatic lifeform to environment comprising:
a) elements recite in claim 2-3 further comprising a series of riser a series of multiple conduit and a series of double clam forming a series of level said level further comprising two series of vacuum port a hot water outlet and an air port 14.

2. The method of achieving self-photohygienic aerobe hydraulic conduits
a) comprising: elements recite in claim 1-3 further comprising a recycling drainage and a sewage drainer a series of hot water circulator an air and water circulator a Faucet a set of lower water circulator an air pump a water heater a optional hot water pump a wet/dry vacuum a set of upper water circulator a acclimate extension a hot acclimate a cold acclimate an optional acclimate and a main cold water inlet.

3. The method of generating a self-photoperiodic acclimatization aquatic pedestal comprising: elements recited in claim 1-2.
a) further comprising a portable UV lamp and a series of threaded crystal install to said multiple conduit and said portable UV lamp constructed of anodized aluminum defining an oxide surface later coated in TiO₂ said series of threaded crystal having a set of cylindrical quartz and a plastic casket said plastic casket having an inner octagon shape and a retainer groove said retainer groove couples to the portable UV lamp further comprising a set of rubber seal attached to a core
b) said core consisting of a thin glass tube wrap around forming a top connector a bottom connector said bottom connector couple to a flexible tubing a aquarium valve and a valve adopter said valve adopter comprising a Flexible rubber and an octagon housing connected to the multiple conduits defining support for a series of aquarium constructed of photohygienic glass
c) said photohygienic glass comprising a set of single glass and a silicon layer defining a self-photohygiene aquarium.

4. The method of improving aerobe hydraulic photosterilization comprising:
elements recited in claim 3a.

5. The method of creating continuous magnetic field conductivity comprising:
elements recited in claim 3a.

6. The method of photosynthesizing aerobe hydraulic effluent generating ozonization
comprising: elements recited in claim 3a.

7. The method of achieving photoperiodic and photocontinuum incubate subject to disease aquatic lifeform comprising: elements recited in claim 3a.

8. The method of prolonging photoexposure among substances comprising:
elements recited in claim 3b.

9. The method of accessing abrupt aerobe hydraulic effluent assimilates immediate photosterilization comprising: elements recited in claim 1-3.

10. The method of improving ozonization and synergistic radiation comprising:
elements recited in claim 1-3.

11. The method of photoexposing aerobe hydraulic effluent impeding Sol-gel physical contact comprising: elements recited in claim 1-2 and 3a, b.

12. The method of preventing hydraulic and organic effluent descent into reservoir comprising: elements recited in claim 1-3.

13. The method of achieving self-photohygienic aquarium whereby aquatic chemistry impedes nitrate accumulation comprising: elements recited in claim 3c.
